(19) United States
(12) Patent Application Publication
(10) Pub. No.: US 2009/0194602 A1
(43) Pub. Date: Aug. 6, 2009

(54) ADDITIONAL HEATING DEVICE FOR A MOTOR VEHICLE

(75) Inventors: Loic Martin, Gif sur Yvette (FR); Severine Asfaux, Chatenay Malabry (FR); Eric Jacquelet, Beynes (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 11/917,066

(22) PCT Filed: May 19, 2006
(86) PCT No.: PCT/FR06/50463

§ 371 Date: Mar. 17, 2009

(30) Foreign Application Priority Data
Jun. 9, 2005 (FR) 0505858

(51) Int. Cl. B60H 1/04; F02M 25/07

(52) U.S. Cl. 237/12.3 R; 123/568.12

(57) ABSTRACT

An additional heating device for a motor vehicle. The device includes a unit heater heated by internal combustion engine coolant, and a circuit for recycling exhausts gases from the engine, including an exchanger for cooling the exhaust gases, which is cooled by the engine coolant, the exchanger being connected in parallel with the coolant circuit that is connected to the unit heater. The exhaust gas recycling circuit includes a valve for controlling the flow of recycled exhaust gases to the engine intake. The gas recycling circuit includes a bypass for directing the exhaust gases towards the exhaust manifold of the engine, the bypass including a valve controlling the exhaust gases returning to the exhaust.

The present invention relates to an additional heating device for a motor vehicle.

The device used for heating the cabin of motor vehicles usually comprises a unit heater, that is to say a liquid-air exchanger which is heated by the liquid coolant used to cool the internal combustion engine.

Some engines of the diesel engine type comprise a circuit for recirculating exhaust gases to the inlet side of the engine, making it possible to reduce the level of NOx in the exhaust gases, that is to say to reduce the pollution caused by these gases. This circuit for recirculating the exhaust gases is commonly known as the EGR circuit.

As shown by FIG. 1, the EGR circuit comprises, in the known way, an exchanger 1 for cooling the exhaust gases. This exchanger 1 is cooled by the engine coolant 2. The coolant 2 leaving this exchanger 1 flows through the unit heater used for heating, thus contributing to the heating thereof.

In the example of FIG. 1, the EGR circuit comprises, between the exchanger 1 and the inlet side 3 of the engine, a valve 4 for controlling the flow rate of exhaust gases recirculated to the inlet side.

This valve 4 is controlled by a computer 5 which encourages correct engine operation and reduction in pollution.

In the example of FIG. 2 which also relates to a known device, the cooling exchanger 1 of the EGR circuit is placed in series with the unit heater used for heating. The valve 4 that controls the flow rate of exhaust gases recirculated to the inlet side 3 is situated between the exhaust manifold 6 and the exchanger 1.

This arrangement also allows a contribution to be made to the heating of the unit heater.

However, the known embodiments present difficulties in reaching an optimum compromise between good engine operating conditions, good cooling of the recirculated gases, excellent reduction in the pollution of these gases, and a good contribution toward the additional heating of the unit heater.

Thus, given that the reduction in pollution and good engine operating conditions take priority, the known devices are unable to provide an effective contribution toward the heating of the unit heater, particularly when the outside temperatures are low.

It is an object of the present invention to provide a solution to the abovementioned problem.

The invention is thus aimed at an additional heating device for a motor vehicle comprising a unit heater which is heated by the liquid coolant used to cool the internal combustion engine of this vehicle, an EGR circuit for recirculating the exhaust gases of this engine which comprises an exchanger for cooling the exhaust gases which is cooled by the engine coolant, this exchanger being connected in parallel with the coolant circuit which is connected to the unit heater, the EGR circuit comprising a valve for controlling the flow rate of exhaust gases recirculated to the inlet side of the engine.

According to the invention, this device is characterized in that the EGR circuit comprises a branch diverting the exhaust gases to the exhaust manifold of the engine, this branch containing a valve to control the return of exhaust gases to the exhaust side.

The device according to the invention thus comprises two valves, the first for controlling the flow rate of exhaust gases to the inlet side, as in the case of the known devices, and the second allowing the gases which have passed through the exchanger to return to the exhaust pipe.

Appropriate control of these two valves through the use of a computer makes it possible to obtain a good compromise between correct engine operation, good reduction in the pollution of the exhaust gases and the additional heating demand of the unit heater.

In a first embodiment of the device according to the invention, the valve for controlling the flow rate of exhaust gases recirculated to the inlet side is positioned in that part of said EGR circuit which lies between the exhaust exchanger and the inlet side of the engine, and said branch is situated between the exchanger and the exhaust manifold.

In a second embodiment of the device according to the invention, the valve for controlling the flow rate of exhaust gases recirculated to the inlet side is positioned toward that part of said EGR circuit that lies between the exhaust manifold and said exchanger, and said branch is also situated between the exhaust manifold and said exchanger.

The computer or computers intended to control the aforementioned two valves are preferably programmed to control these valves as follows:
if pollution reduction and additional heating are both required:
the valve controlling the flow rate of exhaust gases to the inlet side of the engine is partially or fully opened, and
the valve controlling the return of exhaust gases to the exhaust side is fully opened,
if only additional heating is required:
the valve controlling the flow rate of exhaust gases to the inlet side is fully closed,
the valve returning exhaust gases to the exhaust side is fully opened,
if neither is required:
the aforementioned two valves are both closed.

Other particulars and advantages of the invention will become further apparent in the description which follows.

In the attached drawings which are given by way of nonlimiting examples:

FIG. 1 is a diagram of a known EGR circuit,

FIG. 2 is a diagram of another known EGR circuit,

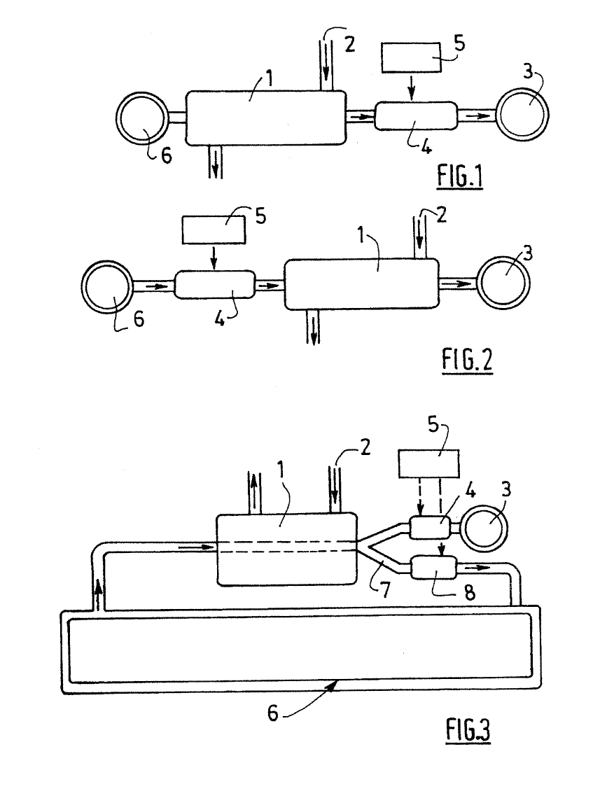

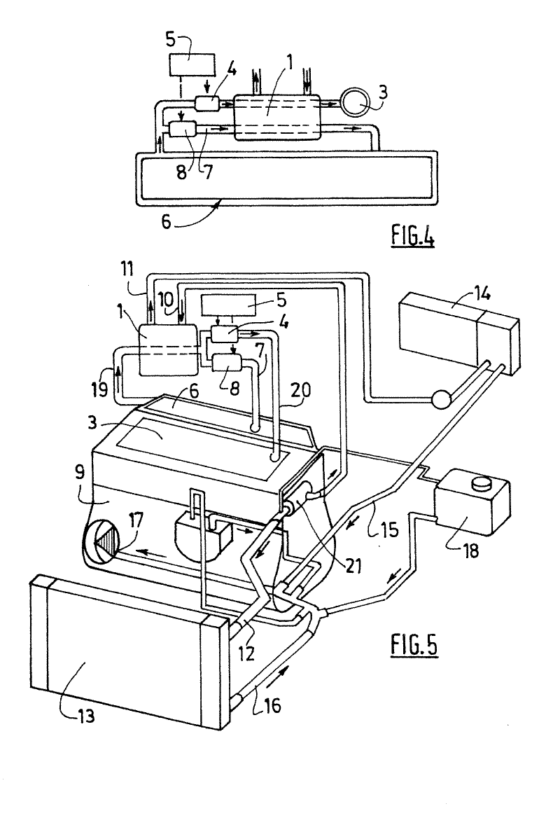

FIG. 3 is a diagram of a modified EGR circuit according to a first version of the invention,

FIG. 4 is a diagram of a modified EGR circuit according to a second version of the invention,

FIG. 5 is an overall diagram of the device for cooling a combustion engine, comprising a modified EGR circuit according to the invention.

In the example depicted in FIG. 3, the modified EGR circuit according to the invention comprises, as before, an exchanger 1 for cooling the exhaust gases which is cooled by the coolant 2 of the combustion engine. This exchanger 1 is connected in parallel with the coolant circuit which is connected to the unit heater used for heating. The EGR circuit comprises a valve 4 for controlling the flow rate of exhaust gases recirculated to the inlet side 3 of the combustion engine.

According to the invention, the EGR circuit comprises a branch 7 diverting the exhaust gases to the exhaust manifold 6 of the engine. This branch 7 contains a valve 8 for controlling the return of exhaust gases to the exhaust side 6 of the engine. This valve 8 is, like the valve 4, controlled by a computer 5.

In the version depicted in FIG. 3, the valve 4 for controlling the flow rate of exhaust gases recirculated to the inlet side 3 is positioned on that part of the EGR circuit that lies between said exchanger 1 and the inlet side 3 of the engine, and the branch 7 is situated between the exchanger 1 and the exhaust manifold 6 of the engine.

In the second version of the invention which is depicted in FIG. 4, the valve 4 for controlling the flow rate of exhaust gases recirculated to the inlet side 3 is positioned on that part of the EGR circuit that lies between the exhaust manifold 6 and the exchanger 1, and the branch 7 containing the second valve 8 is situated between the exhaust manifold 6 and the exchanger 1.

In this example, the two valves 4 and 8 are also controlled by a computer 5.

FIG. 5 shows, in detail, the device for cooling the combustion engine 9 of a motor vehicle and the modified EGR circuit according to the invention.

The exchanger 1 is connected with a coolant inlet pipe 10 and a coolant outlet pipe 11. The inlet pipe 10 is connected to the engine 9 water outlet header 21. The coolant outlet pipe 11 from the exchanger 1 of the EGR circuit is connected to the unit heater 14 used to heat the cabin of the vehicle. The outlet from the unit heater 14 is itself connected by a pipe 15 to the coolant outlet pipe 16 from the radiator 13 which sends this liquid into the engine 9 at 17. The reference 18 denotes the expansion vessel in the cooling circuit.

The exhaust gases leaving the exhaust manifold 6 along a pipe 19 pass through the exchanger 1 in which these gases are cooled by the engine coolant.

On leaving the exchanger 1, the cooled exhaust gases are sent, by virtue of the valves 4, 8 controlled by the computer 5:
a) either both to the inlet manifold 3 along the pipe 20 and to the exhaust manifold 6 along the diversion branch pipe 7, both valves 4 and 8 being open,
b) or only to the exhaust manifold 6 along the pipe 20, the valve 4 being closed and the valve 8 open,
c) or no gas flows through the pipes 20 and 7, both valves 4 and 8 being closed.

In case a), the simultaneous requirements for reducing pollution and providing the unit heater 14 with additional heating are both met. These two requirements may be apportioned to suit the circumstances by varying the extent to which the valve 4 which regulates the flow rate of gases to the inlet side is opened.

The valve 8 may be a valve of the open/closed type controlled in the conventional way with the same strategy as immersion heaters and PTC (positive temperature coefficient) resistors.

In case b), the exhaust gases are used only to heat the coolant sent to the exchanger 1 and then to the unit heater 14 in order to meet a heating requirement.

In case c), no requirement is met.

1-6. (canceled)

7. An additional heating device for a motor vehicle comprising:
a unit heater heated by liquid coolant used to cool an internal combustion engine of the vehicle;
an EGR circuit for recirculating exhaust gases of the engine, which comprises an exchanger for cooling the exhaust gases cooled by the engine coolant, the exchanger being connected in parallel with the coolant circuit that is connected to the unit heater,
wherein the EGR circuit includes a first valve for controlling flow rate of exhaust gases recirculated to an inlet side of the engine,
wherein the EGR circuit includes a branch diverting the exhaust gases to an exhaust manifold of the engine, the branch including a second valve for controlling return of exhaust gases to the exhaust manifold side.

8. The heating device as claimed in claim 7, wherein the valve for controlling the flow rate of exhaust gases recirculated to the inlet side is positioned on a part of the EGR circuit that lies between the exchanger and an inlet side of the engine, and the branch is situated between the exchanger and the exhaust manifold of the engine.

9. The heating device as claimed in claim 7, wherein the first valve for controlling the flow rate of exhaust gases recirculated to the inlet side is positioned on a part of the EGR circuit that lies between the exhaust manifold and the exchanger, and the branch is situated between the exhaust manifold and the exchanger.

10. The heating device as claimed in claim 7, wherein the first and second valves are controlled by a computer.

11. The heating device as claimed in claim 7, wherein the exchanger is connected with a coolant inlet pipe and a coolant outlet pipe, the inlet pipe being connected to an engine water outlet header, the outlet pipe from the exchanger being connected to the unit heater, which unit heater is connected to the outlet pipe from the radiator.

12. The heating device as claimed in claim 10, wherein the computer is programmed to control the first and second valves as follows:
if pollution reduction and additional heating are both required:
the first valve controlling the flow rate of exhaust gases to the inlet side of the engine is partially or fully opened, and
the second valve controlling the return of exhaust gases to the exhaust side is fully opened;
if only additional heating is required:
the first valve controlling the flow rate of exhaust gases to the inlet side is fully closed, and
the second valve returning exhaust gases to the exhaust side is fully opened; and
if neither is required:
the first and second valves are both closed.
